(19) United States
(12) Patent Application Publication
(10) Pub. No.: US 2020/0328443 A1
(43) Pub. Date: Oct. 15, 2020

(54) A PORTABLE GENERATOR APPARATUS

(71) Applicant: IHOD LIMITED, Chichester West Sussex (GB)

(72) Inventor: Mark Collins, Chichester West Sussex (GB)

(21) Appl. No.: 16/093,698

(22) PCT Filed: Apr. 12, 2017
(86) PCT No.: PCT/EP2017/058782

§ 371 Date: Oct. 15, 2018

(30) Foreign Application Priority Data
Apr. 15, 2016 (GB) 1606589.8

(51) Int. Cl. H01M 8/0612; H01M 8/04082; H01M 8/0432; H01M 8/0438; H01M 8/0662; H01M 2/02; C01B 3/08; B01J 19/24

(52) U.S. Cl. CPC H01M 8/0631; H01M 8/04201; H01M 8/04373; B01J 19/24; H01M 8/0662; H01M 2/02; C01B 3/08; H01M 8/04425

(57) ABSTRACT

The invention provides an apparatus comprising a generator enclosed within a casing (4, 6) shaped to allow it to be rolled about one or more axes, the apparatus being provided with stabilising means (50a, 50b, 50c) that can be arranged to hold the apparatus in a desired orientation on an underlying surface and prevent the apparatus from rolling on the underlying surface when it is desired to use the generator.

This invention relates to a portable generator apparatus, and in particular a portable generator apparatus for generating hydrogen and consuming the hydrogen to provide electrical power.

### BACKGROUND OF THE INVENTION

In recent years, fuel cells have become increasingly popular as a means of generating electricity in situations where there is no mains power available. Fuel cells typically run on hydrogen and have a number of advantages over internal combustion engines traditionally used in stand-alone power generators. Thus, the waste product of the operation of a fuel cell run on hydrogen is solely water, and no carbon dioxide or carbon monoxide is produced. Fuel cells are also more efficient than internal combustion engines. A further advantage of a fuel cell compared to a conventional petroleum burning generator is that fuel cells can be miniaturised, thereby making them more portable. One example of a portable fuel cell is the proton exchange membrane (PEM) fuel cell.

However, a problem with the use of hydrogen-based fuel cells is that they require a supply of hydrogen. In many remote locations and field situations, a supply of hydrogen may simply be unobtainable. Thus, currently, the use of hydrogen-based fuel cells is limited by the difficulties in obtaining or maintaining a supply of hydrogen.

It has long been known that hydrogen can be generated by the reaction of various metals with acid or alkali. For example, U.S. Pat. No. 4,325,355 (Molecular Energy Corp.) describes a heating system in which an exothermic reaction between a solid metal and a solution takes place in a reactor containing a heat exchanger. In the specific reaction system described, aluminium pieces are lowered into a solution of sodium hydroxide solution. During the reaction between aluminium and sodium hydroxide solution, the aluminium is converted to aluminium hydroxide with the evolution of hydrogen gas. The aluminium hydroxide reacts with the sodium hydroxide to form sodium aluminate.

The generation of hydrogen by the reaction of aluminium with sodium hydroxide is also described in US2009/0252671 (Fullerton).

The hydrogen generating apparatuses of the type described above are relatively large scale fixed installations that are not readily suited to portable use.

WO2012/140170 (Collins) discloses an apparatus for heating a liquid, for example in a domestic water heating system. The apparatus of WO2012/140170 is intended to produce heat and provides an alternative to heating systems making use of electricity or the burning of fossil fuels. Heat is produced by the exothermic reaction of sodium hydroxide and aluminium and the heat is then harvested by means of a heat exchanger on or in the reaction vessel. Further heat is produced by burning the hydrogen generated by the reaction.

GB2164634A (General Electric Company) discloses a metallic hydride hydrogen storage for balloon inflation, wherein a matrix of decomposable metallic hydride is enclosed within a spherical containment shell. The hydrogen generation system disclosed within this document is intended for inflating thin film balloons launched from rockets at high altitudes (such as 70,000 to 100,000 feet).

EP2716598A1 (Panasonic Corporation) discloses a hydrogen generator including a tubular reformer which generates a hydrogen-containing gas by a reforming reaction.

At present, there remains a need for an apparatus that is more compact and more readily transported than known systems for generating hydrogen and which can provide hydrogen on demand in remote or field situations where it is not possible or practicable to use hydrogen storage containers such as gas cylinders.

### The Invention

It is an object of the present invention to provide a compact and readily transportable apparatus for the generation of hydrogen to provide electrical power in remote locations.

It is a further object of the invention to provide a portable generator that can be moved over the ground, or another underlying surface, in a rolling motion.

Accordingly, the invention provides an apparatus comprising a generator enclosed within a casing shaped to allow it to be rolled about one or more axes, the apparatus being provided with stabilising means that can be arranged to hold the apparatus in a desired orientation and prevent the apparatus from rolling when it is desired to use the generator, wherein the stabilising means comprise one or more movable elements that are arranged to move between a stowed configuration, in which rolling of the apparatus is not impeded, and an extended configuration in which the movable elements prevent rolling of the apparatus from taking place.

The invention also provides an apparatus comprising a generator enclosed within a casing shaped to allow it to be rolled about one or more axes, the apparatus being provided with stabilising means that can be arranged to hold the apparatus in a desired orientation and prevent the apparatus from rolling when it is desired to use the generator.

The generator can be a generator that produces electricity, or it may be a generator that produces a substance (e.g. hydrogen) that can readily be converted to produce electricity.

In one embodiment, the generator produces hydrogen that may be consumed by a hydrogen-consuming electricity generating device to produce electricity. The hydrogen-consuming electricity generating device may be located inside the casing or may be external to the casing.

Thus, the apparatus of the invention may comprise a generator for generating hydrogen and a hydrogen-consuming electricity generating device to produce electricity.

In one embodiment, a generator for generating hydrogen and a hydrogen-consuming electricity generating device are both contained within the casing.

In another embodiment, the casing contains a generator for generating hydrogen but does not contain a hydrogen-consuming electricity generating device. An apparatus according to this embodiment is typically connectable to an external device for consuming electricity to produce electricity.

In a further embodiment, the apparatus comprises a generator for generating hydrogen enclosed within the casing, and an external (i.e. external with respect to the casing) device for consuming hydrogen to generate electricity; said external device being connected or connectable to the generator for generating hydrogen.

In some embodiments, the apparatus may comprise a chemical reactor for generating hydrogen and a fuel cell for consuming the hydrogen to generate electricity, the chemical reactor and fuel cell both being contained within the casing.

The casing is shaped to allow it to be rolled about one or more axes. In this way, the apparatus can readily be moved around by a person or persons without the need for the person(s) to carry the apparatus. The apparatus is therefore particularly well suited for use in rough terrain and locations where there are no roads or where road networks are rudimentary. Thus, the apparatus of the invention can be carried by road to a drop-off point closest to the site of intended use and then rolled from the drop-off point to the site of use. In very remote locations, the apparatus can be carried by air (e.g. helicopter) to a drop-off location and then rolled to the site of intended use. The apparatus of the invention can be use, for example, in remote rural locations and in emergency or disaster situations.

To allow it to be rolled about one or more axes, the casing typically has one or two main axes of rotation.

In one embodiment, the casing has a single axis of rotation.

The casing may comprise a main body (which may also be referred to herein as the casing body) and one or more ground engaging elements which are configured to allow the casing to be rolled.

In some embodiments, the main body may be spherical, substantially spherical, cylindrical or substantially cylindrical, or barrel-shaped. In one particular embodiment, the main body is substantially spherical.

In another embodiment, the main body may be substantially polygonal prism-shaped. Where the main body is polygonal-prism shaped and the casing does not comprise additional ground engaging elements, the prism is formed from a polygon with at least 6 rectangular faces (i.e. at least hexagonal prismatic) and more typically at least 8, or at least 10, or 12 or more rectangular faces, to allow for rolling of the casing body. The edges of the prism (and in particular the transverse edges—i.e. the edges connecting the two polygonal end faces) may be curved or rounded to allow for easier rolling of the casing. When the body is cylindrical or prismatic, the ends of the body may either be flat or rounded.

When the main body is spherical, substantially spherical, cylindrical or substantially cylindrical or barrel-shaped, the casing may be rolled about the circumference of a circular or substantially circular face of the body. The ground engaging elements may therefore be panels or surfaces of the casing

Where apparatus is of a polygonal prism shape having a sufficiently large number of sides to permit the apparatus to be rolled, the surfaces or faces of the prism shape may serve as the ground engaging elements.

It is preferred however that the ground engaging elements take the form of protrusions or extensions of the main body, Such protrusions or extensions may be formed integrally with the main body, or formed separately and then attached to the main body (for example by welding or by means of fastening elements such as bolts, screws or rivets). The ground engaging elements may take the form of circumferential ribs, flanges, rails, or tubes.

In one embodiment, the ground engaging elements comprise a plurality (e.g. two) of rails which are circular or substantially circular in shape and encircle the casing. The rails may be welded to the body of the casing at one or more points around its periphery.

In addition to facilitating the rolling of the apparatus, ground engaging elements in the form of protrusions or extensions of the main body may serve as strengthening elements to provide resistance to crushing or buckling.

More generally, the casing body may be provided with one or more strengthening elements to provide resistance against compression and/or to prevent the casing body from buckling. The strengthening elements can be present on an outer surface of the casing body or the interior of the casing body, or both. Such external strengthening elements may be in addition to any ground engaging elements in the form of protrusions or extensions of the main body that may be present.

The strengthening elements may take the form of bracing struts or supporting ribs or a combination thereof.

In one embodiment, where the casing body is spherical or substantially spherical, the body is provided with one or more bracing struts which each extend from one location on an inner wall of the casing body across the interior of the casing body to another location on an inner wall of the casing body.

For example, a bracing strut may extend across the interior of the casing body and may take the form of a centrally located column, connecting two opposite locations on an inner surface of the body.

The centrally located column may, for example, lie along an axis substantially perpendicular to a rolling axis of the apparatus, for example along an axis within ±5° of perpendicular or within ±3° of perpendicular, in particular within ±1° of perpendicular. Alternatively, the centrally located column may lie along an axis substantially parallel to a rolling axis of the apparatus for example along an axis within ±5° of parallel or within ±3° of parallel, in particular within ±1° of parallel. In one embodiment, the centrally located column lies along an axis perpendicular or parallel to a rolling axis of the apparatus. In one embodiment, the column is tubular, and may for example be circular in cross section. The centrally located column may thus be hollow.

The main body (casing body) may comprise two or more separate casing components (e.g. panels or hollow shell members) which can be connected together in such a way that they can be partially or fully separated to allow access to the interior of the casing.

The casing components may take the form of panels or hollow shell members which when secured together define the overall shape of the casing body.

For example, the casing body may comprise a pair of hollow shell members that are removably or hingedly connected together so that the casing body can be opened to give access to its interior.

The hollow shell members may, for example, each be substantially hemispherical in shape so that, when connected together, they form a substantially spherical casing body.

In another embodiment, the casing body comprises a pair of substantially hemicylindrical shell members that are removably or hingedly connected together to form a substantially cylindrical casing.

In a particular embodiment, the casing body comprises upper and lower shell members (e.g. substantially hemispherical or substantially hemicylindrical shell members), the terms “upper” and “lower” referring to the orientation of the apparatus when in use as a generator.

The apparatus is provided with stabilising means that can be arranged to hold the apparatus in a desired orientation (e.g. an upright orientation) on an underlying surface and prevent the apparatus from rolling on the underlying surface when it is desired to use or store the generator.

The stabilising means may comprise one or more movable elements that can be moved or removed to prevent the apparatus from rolling when in use.

The stabilising means may comprise a plurality of legs or other protrusions.

The movable elements can be arranged to move between a stowed configuration, in which rolling of the apparatus is not impeded, and an extended configuration in which the movable elements prevent rolling of the apparatus from taking place.

The stowed configuration may be one in which the moveable elements are retracted or folded into the casing. For example, the moveable elements may take the form of retractable elements (e.g. legs) that can be stowed by retraction into holes, recesses or sockets in the casing. Alternatively, the moveable elements can take the form of pivotable or foldable legs that can be stowed by virtue of being foldable into a hole or recess in the casing body.

In one embodiment, the stabilising means comprises a plurality of retractable legs. The retractable legs may be present in the form of a single retractable tripod which is typically arranged to fold or collapse to enable it to be retracted into the casing body.

In another embodiment, a plurality of (preferably three or more, e.g. three or four, and most typically three) independently retractable legs may be provided.

The retractable elements (e.g. legs) may be retractable into one or more sockets in the casing body. Where the apparatus comprises a centrally located column as described above, the column may have a hollow interior and tubular structure which serves as a socket such that a single retractable tripod may be folded and then retracted into the socket.

Alternatively, the casing may be provided with a plurality of sockets in which a plurality of retractable legs may be independently extended and retracted. In one embodiment, the casing is provided with three sets of retractable legs and sockets.

The stabilising means (e.g. moveable elements such as foldable or retractable elements, for example legs) may also be provided with locking means to prevent the support stands from extending whilst the apparatus is being transported. The locking means may, for example, take the form of slidable locking bolts, which align with holes in the legs and corresponding sockets to prevent the legs from sliding within the sockets.

The retractable elements (e.g. legs) may be spring loaded whereby they can be pushed inwardly to release them from a locked position such that they then spring out to an extended position.

As an alternative to foldable or retractable elements (e.g. legs), the stabilising means can comprise a detachable cover portion, which covers a roll-preventing surface of the casing body. The detachable cover portion is shaped such that when attached to the body, the overall shape of the body is preserved. When the detachable cover portion is removed, a roll-preventing surface of the casing body may be exposed, which may serve as a base for the apparatus, to prevent the apparatus rolling during generation. The roll-preventing surface can be simply a flat surface, or it can be a surface provided with one or more protrusions or other formations that prevent rolling.

The generator within the casing may produce electricity or substances which can readily be converted to produce electricity.

The generator may be set up to facilitate a chemical reaction between two components, including combustion reactions. The apparatus of the invention may therefore contain an internal combustion engine and means for holding (or connection to) a supply of fuel (e.g. petroleum, gasoline, diesel, alcohol) for the combustion engine. The power provided by the internal combustion engine can be used to drive an electricity generator which is also located within the casing.

More preferably, however, the apparatus of the invention contains a reactor for generating hydrogen by the reaction of two or more reactants.

Still more preferably, the apparatus contains a device for consuming the hydrogen generated and thereby producing electricity. The device for consuming the hydrogen can be, for example, a hydrogen-powered internal combustion engine or a fuel cell. Preferably the device for consuming the hydrogen and producing electricity is a fuel cell.

Accordingly, the apparatus may comprise a plurality of components that together constitute a reaction system for generating hydrogen. The components typically include:
a reactor (in which two or more substances can be reacted to form gaseous hydrogen), the reactor having one or more reactant inlets; and
electronic monitoring and control means for monitoring and controlling the reaction between the reactants;
and preferably also one or more further components selected from:
one or more pumps (e.g. peristaltic pumps) for pumping the reactants into the reactor;
a waste container for collecting spent reactants;
a buffer tank for temporary storage of hydrogen;
one or more sensors (e.g. selected from a temperature sensor, pressure sensor and optionally a pH sensor) for monitoring a physical or chemical parameter of the reaction system, the one or more sensors being operatively linked to the electronic monitoring and control means;
one or more filters or driers (e.g., desiccant air driers) for removing water from the hydrogen;
one or more electrical components selected from electrical converters (e.g. voltage converters or frequency converters), voltage regulators, power inverters, batteries and capacitors.

The reaction system may also comprise one or more reactant containers containing reactants that can be reacted together to form hydrogen which feed the reactants into the reactant inlet(s) on the reactor. The reactant containers may be located inside the casing. Alternatively, the reactants can be fed from reactant containers located outside of the casing through one or more openings in the casing to the reactant inlets on the reactor.

Where the apparatus comprises an apparatus for the generation of hydrogen, in use, the pumps pump reactants from the one or more reactant containers into the reactor. The reactants are chosen such that the reaction between them forms hydrogen gas. An example of a pair of reactants suitable for use in generating hydrogen consists of aqueous sodium hydroxide and aluminium (e.g. aluminium powder).

Accordingly, in a further aspect of the invention there is provided with a reactant system for a hydrogen generating reactor comprising:
i) a container containing a solution of sodium hydroxide: and
ii) a container containing an aqueous suspension of aluminium particles and a suspending agent.

In one embodiment, the suspending agent is a polysaccharide, such as starch.

Hydrogen produced in the reactor typically contains some water vapour which can be removed by passing through a drying system. The drying system can comprise a water trap and a separate desiccant air dryer in the form of a cartridge or column containing a desiccant material.

The reaction system may comprise a buffer tank which receives the hydrogen produced in the reactor and provides a means of temporary storage of hydrogen and smoothing the pressure of hydrogen before it passes to a device (e.g. a fuel cell) for consuming hydrogen and producing electricity.

Sensors and electronic means for controlling the apparatus are typically provided to control the dispensing of reactants from the reactant containers and thereby control the output pressure of hydrogen in the apparatus.

The hydrogen generated in the reactor system can be delivered to a fuel cell for the production of electricity. The fuel cell may either be contained within the casing of the apparatus or externally connectable to the generator of the apparatus. In one embodiment, the fuel cell is contained within the casing.

The fuel cell may be a proton exchange membrane (PEM) fuel cell. PEM fuel cells are well known and are commercially available. Alternatively, but less preferably, the fuel cell may produce electricity through the controlled combustion of the produced hydrogen gas.

Where a fuel cell is present within the casing of the apparatus, the apparatus may also comprise an AC-DC invertor to convert the DC power produced by the fuel cell to AC power for use (or vice versa).

Some commercially available fuel cells make use of an operating cycle wherein hydrogen is purged from the cells at regular intervals. Rather than waste the hydrogen, the apparatus may be arranged to recycle hydrogen purged from the fuel cell back into the fuel cell.

The apparatus typically comprises electronic monitoring and control means for monitoring and controlling the operation of the apparatus. The electronic monitoring and control means may include a data output device for providing information about measurable properties of the generator, for example fuel levels, generator state, hydrogen output pressure and electrical output.

The electronic monitoring and control means may also include one or more input devices for activating and/or controlling the apparatus. In one embodiment, the input means merely comprises one or more on/off switches, to allow the generator to be started or stopped. The switches may also be illuminated to signal to the user whether the generator is in operation. Preferably however, the one or more input devices enables the operating parameters of the apparatus to be controlled according to need. For example, the input device may allow the user to specify a number of parameters including the type of reactants to be used, the desired hydrogen output pressure, or the desired electrical output.

In one embodiment the input device and data output device may both be constituted by a touch screen user interface.

The input device and data output device may be contained within the casing so that the casing must be opened to provide access to the devices, or the input and output devices may be mounted on, or in the apparatus so that they are accessible from the exterior of the casing. In one embodiment, an on-off switch may be provided on the exterior of the casing and a further input device and/or a data output device may be concealed within the casing. In a further embodiment, the electronic monitoring and control means may comprise a processer which is mounted in a wall of the apparatus so that a visual display screen (which may also be a touch screen allowing the input of commands to the apparatus) of the processer is visible from the exterior of the apparatus.

The electronic monitoring and control means may be provided with a telecommunications link (e.g. a satellite link) so that operational parameters of the apparatus can be monitored remotely.

During operation, the generator will typically generate heat. In order to remove excess heat, the casing may be provided with one or more air vents to allow hot air to escape. The casing may also contain a fan to facilitate removal of hot air and allow cooling of the apparatus. The air vents may be located in an upper part of the casing. The upper part of the casing may be provided with a lid, which can be adjusted (e.g. upwards or downwards) to increase or decrease the size of an air passage between the casing and the lid through which air can pass.

The various components within the casing are typically arranged so as to allow for uniform and even rolling of the apparatus. The inside of the casing body is therefore typically provided with securing elements to allow the internal components of the apparatus to be secured in place. The securing elements may take the form of brackets, clamps, frame members, sockets or bays which are shaped to receive particular components.

### BRIEF DESCRIPTION OF THE DRAWINGS

FIG. 1 is a side view of the apparatus according to a first embodiment of the invention.

FIG. 2a is a view of the apparatus in FIG. 1 with the upper shell member removed.

FIG. 2b is a view from above of the apparatus in FIG. 1 with the upper shell member removed.

FIG. 3 is a cross-sectional side view of the apparatus with the top shell and components of the hydrogen generation apparatus removed.

FIG. 3a is a view along line B-B in FIG. 3.

FIG. 4 is a side view of the lower shell of the apparatus.

FIG. 5a is a view from above and to one side of the upper shell member of the apparatus of FIG. 1 but with an air vent cap removed.

FIG. 5b is a view of the underside of the upper shell member of FIG. 5a

FIG. 6a is a view from beneath of the air vent cap omitted from the upper shell member in FIG. 5a.

FIG. 6b is a cross-sectional view of the air vent cap of FIG. 6b.

FIG. 7 is a side view of the centre column bracing member of the apparatus of FIGS. 1 to 6b. The dimensions given in this drawing are for illustration purposes only and are not intended to be limiting.

FIG. 8 is a side view of a folding tripod from the apparatus of FIGS. 1 to 7 in a stowed configuration.

FIG. 9 is a sectional elevation through the centre column bracing member of FIG. 7 showing the tripod stowed within the centre column.

FIG. 10 is a perspective view of the apparatus of FIGS. 1 to 9 resting on the extended tripod stand.

FIG. 11 is a view of the apparatus of FIGS. 1 to 10 in the orientation in which it can be rolled along a surface.

FIG. 12 is a perspective view from above of the lower shell member with the components of the hydrogen generation apparatus removed.

FIG. 13 is a side view of the reactor vessel and stirrer of the apparatus of FIGS. 1 to 12.

FIG. 14 is a perspective view of the reactor vessel and stirrer of FIG. 13.

FIG. 15 is a cross-sectional view of the apparatus according to a second embodiment of the invention with the top shell and components of the hydrogen generation apparatus removed.

FIG. 16 is a perspective view of a component part of the apparatus of FIG. 15, and more particularly a socket structure for accommodating a support leg.

FIG. 17 is a perspective view of a support leg for the apparatus of FIG. 15.

FIG. 18 shows four schematic views of the apparatus of the invention in different orientations.

### DETAILED DESCRIPTION OF THE INVENTION

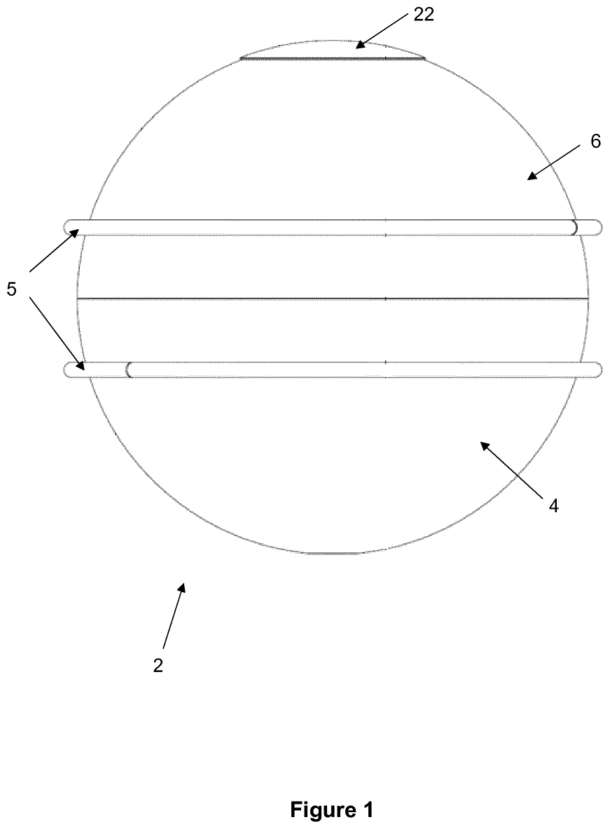

The invention will now be illustrated but not limited by reference to the specific embodiments shown in the drawings FIGS. 1 to 18.

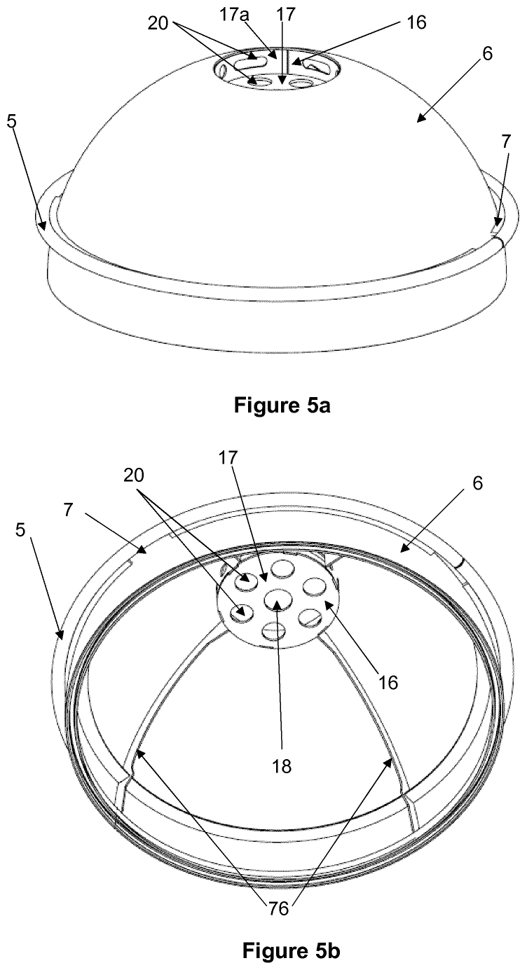

FIG. 1 illustrates an apparatus according to a first embodiment of the invention. The apparatus comprises a substantially spherical hollow casing (2) formed from a lower shell member (4) and an upper shell member (6), both of which are hemispherical and are formed from aluminium. An adjustable air vent cap (22) is mounted in a recess (16) (see FIG. 5a) on the apex of the upper shell member (6).

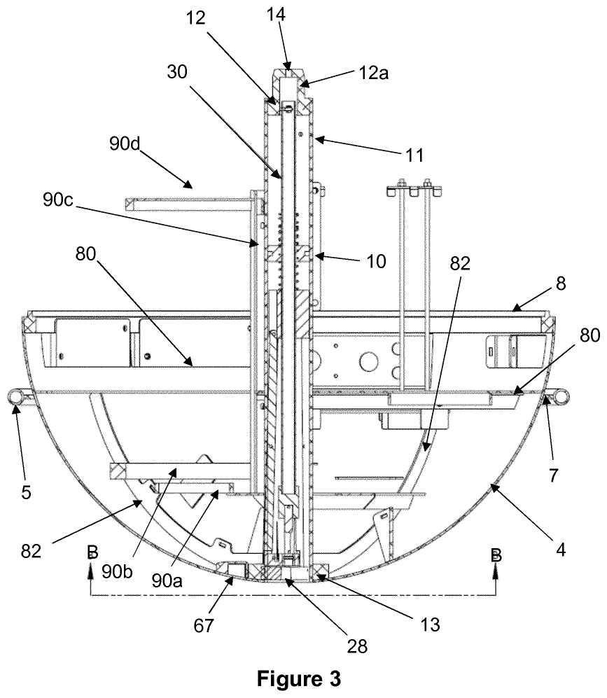

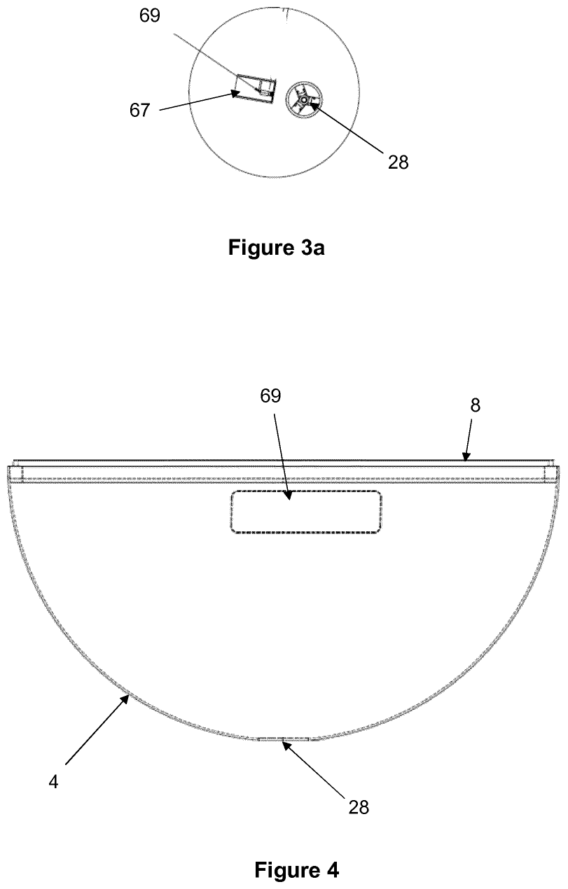

The casing (2) is provided with a pair of circular rails (5) which extend around the outer surface of the casing, one being attached to each of the lower shell member (4) and upper shell member (6). The rails (5) are of tubular construction and have circular cross-sections. The rails (5) are welded to the convex surfaces of the upper and lower shell members (4) and (6) through annular spacer plates (7), as shown in FIGS. 3, 5a and 5b. The two rails (5) act as ground engaging elements when the apparatus is rolled along the ground, as described in more detail below.

As shown in FIGS. 3 and 4, an annular reinforcing member (8) is welded to the concave face of the lower shell member (4). The annular reinforcing member (8) has an upstanding annular rim with a stepped surface either side. The surface of the radially outer stepped surface is flush with the rim of the lower shell member (4).

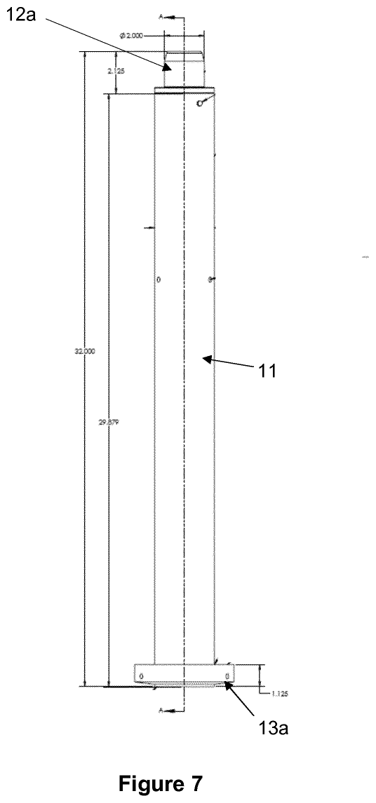

Located inside the housing (2) is a centre column (10) which extends between the top and the bottom of the interior of the casing and serves as a bracing member to provide strength to the casing. The centre column (10), which is shown in enlarged detail in FIGS. 7 and 9, comprises a tube (11) of circular cross section, around the lower end of which is welded a peripheral flange element (13). The peripheral flange element (13) has a curved lower surface (13a), the radius of curvature of which corresponds to the inside radius of curvature of the lower shell member (4). The curved lower surface (13a) of the peripheral flange element (13) is welded to the concave surface of the base of the lower shell member (4) to hold the centre column (12) in place. The lower end of the tube (11) protrudes into a hole (28) in the lower shell member (4) so that the lower end surface of the tube (11) is flush with the convex (i.e. external) surface of the lower shell member (4). The upper end the tube is closed by a machined aluminium plug (12) which has a threaded end portion (12a) and a central, circular, internally threaded hole (14).

As can be seen in FIGS. 5a and 5b, the apex of the upper shell member (6) is provided with a shallow cylindrical recess (16) defined by a tray which is formed from a floor (17) and side wall (17a) and is welded to the rim of a circular opening in the upper shell member (6). The floor (17) of the tray is provided with a central hole (18) which is of a complementary size to the threaded end portion (12a) of the centre column (10). The floor (17) and side wall (17a) of the tray are provided with additional holes (20) which act as ventilation holes.

To assemble the housing (2), the upper shell member (6) is placed onto the lower shell member (4) so that the lower edge of the upper shell member fits over the upstanding rim of the annular reinforcing member (8) on the lower shell member (4) and abuts against the upper edge of the lower shell member (4), and the threaded end portion (12a) of the centre column (10) protrudes through the central hole (18) in the floor (17) of the tray. The upper and lower shells (4, 6) are then secured together by screwing a threaded nut (not shown) onto the free end of the threaded end portion (12a). The close fit between the lower edge of the upper shell member (4) and the upstanding rim of the annular reinforcing member (8) provides a seal against the ingress of foreign materials such as liquids (e.g. rain)

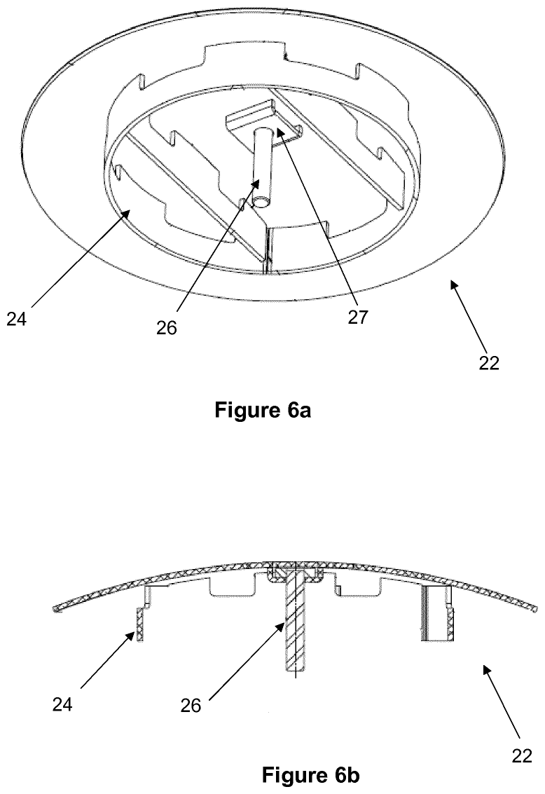

The adjustable air vent cap (22), which is shown in enlarged detail in FIGS. 6a and 6b, is mounted in the cylindrical recess (16) of the upper shell (6), such that the overall spherical shape of the housing is preserved. The cap (22) therefore has a concave and convex surface, and the concave surface is provided with a circular depending wall or skirt (24) which is a close fit in the cylindrical recess (16). A threaded rod (26) extends downwardly from a bracket (27) which is welded to the centre of the concave face of the cap. The thread on the threaded rod (26) is complementary to the threaded hole (14) of the end portion (12a) on the plug (12) in the upper end of the central column (10). The cap (22) can therefore be fixed into position by aligning the circular wall (24) with the cylindrical recess (16) and rotating the cap such that the threaded rod (26) screws into the threaded hole (14) in the end portion. In transport mode, the cap (22) can be screwed fully into the hole (14) so that the upper surface of the cap (22) is substantially flush with the surface of the spherical casing. However, prior to using the generator within the casing, the cap (22) can be unscrewed to create a gap between the cap (22) and the edge of the recess (16) so that hot gases created while the generator is operational can escape through the holes (20) in the floor of the tray (16) and out to the exterior through the gap. It will be appreciated that the gap can be varied by screwing the cap down or up as required.

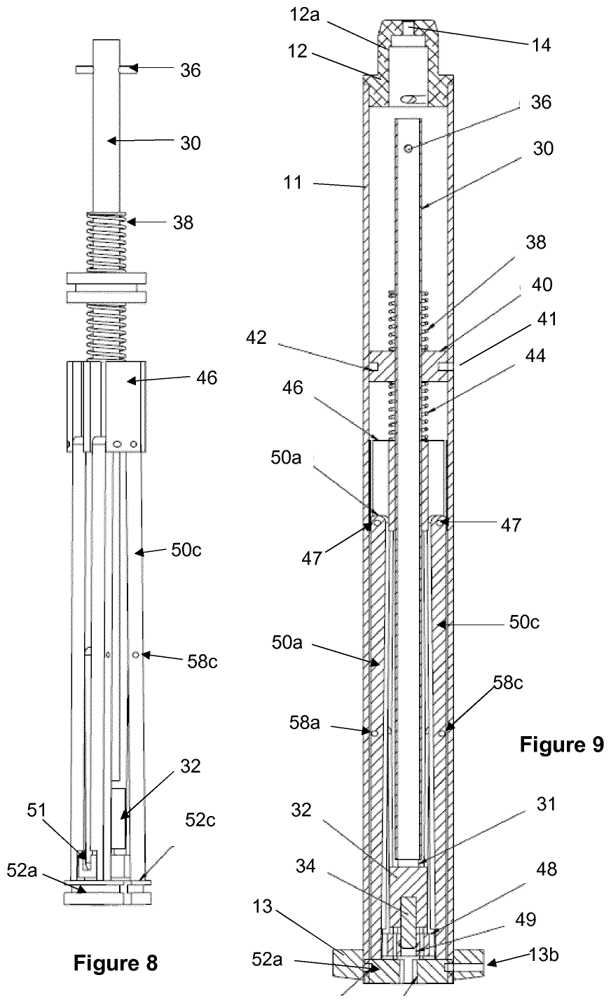

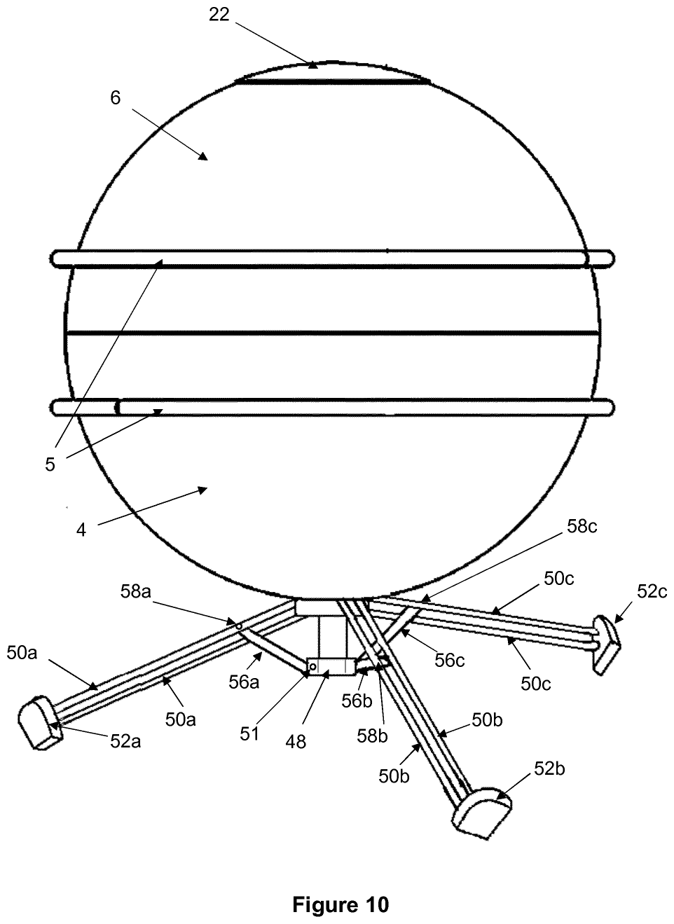

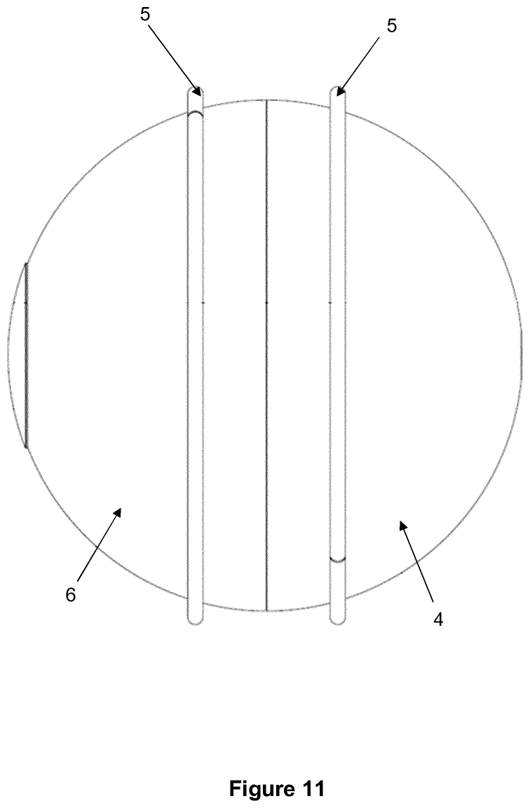

In addition to serving as a bracing member to strengthen the casing against crushing, the centre column also serves as a housing for a collapsible tripod assembly. The apparatus of FIGS. 1 to 9 supported by the tripod is shown in FIG. 10 whereas the component parts of the tripod and the manner in which they are held in a folded state within the centre column are shown in enlarged detail in FIGS. 8 and 9.

The tripod comprises a tubular shaft (30), which is connected via a spigot (31) at the lower end thereof to a cylindrical block (32) having a locating pin (34) extending downwardly therefrom. The tubular shaft is moveable up and down in an axial direction but the extent of travel of the shaft is limited by the transverse bolt (36) and compression spring (38) which sits about the upper end of the shaft between the bolt (36) and guide collar (40). Guide collar (40) is fixed in place by means of retaining screws (not shown) which extend through a hole (41) in the wall of the tube (11) and into an annular groove (42) in the guide collar (40).

Encircling the tubular shaft (30) below the fixed guide collar (40) is a second compression spring (44) which bears against sliding collar (46). The sliding collar (46) has three pivot pins (47) upon which are pivotably mounted three pairs of leg struts (50a), (50b) and (50c). To the lower ends of the leg struts (50a), (50b) and (50c) are attached feet (52a), (52b) and (52c).

Located below the cylindrical block (32) is a strut-mounting hub (48) having a central hole (49) and three clevis-type pivot mountings (51) on which are pivotably mounted three single bracing struts (56a), (56b) and (56c). The other ends of the three bracing struts are pivotably anchored between the pairs of leg struts (50a), (50b) and (50c) by means of pivot pins (58a), (58b) and (58c).

As shown in FIGS. 3 and 3a, the lower shell member (4) is provided with a recess (67) to one side of the hole (28). In the recess (67) is mounted a spring loaded plunger (69) (for example a McMaster-Carr 8498A780 plunger or equivalent), the nose portion of which extends through a lateral channel (13b) in the peripheral flange (13) and engages a part annular groove in one of the feet (52a), (52b) or (52c).

In order to move the apparatus from one location to another, the casing is rotated into the position shown in FIG. 11 so that the two rails (5) are in contact with the ground. The casing can then be rolled along the ground to a desired location. Once the apparatus is at the desired location, the folded tripod can then be extracted from the housing. This may be achieved by retracting the spring-loaded plunger (69) and pushing the feet (52a), (52b), (52c) inwardly against the force of the spring (44) and then releasing the feet so that the compressed spring (44) forces the feet (52a), (52b), (52c), the hub (48) and part of the block (32) out of the housing. The folded tripod may then gradually be pulled out of the housing causing the sliding collar (46) to slide down the rod (30) until the lower end of the sliding collar bearing the pivot mountings (47) for the legs emerges from the housing. As the bottom of the sliding collar (46) emerges from the housing, it pushes the remainder of the block (32) out of the housing. The legs (50a), (50b) and (50c) can then be eased apart towards the spread configuration shown in FIG. 10. As the legs spread apart, so the strut-mounting hub (48) moves back towards the block (32) and the legs can be secured in the spread configuration by pushing the hub (48) against the block (32) so that the locating pin (34) locates in the central hole (49).

Once the legs have been secured in the spread configuration, the apparatus can then be rolled from the position shown in FIG. 11 to the upright position shown in FIG. 10. The arrangement of the legs and the balance of weight within the casing is such that the apparatus can be tipped into the upright position with relatively little effort.

In order to collapse the tripod, the casing (2) is rolled onto its side once more so that it rests on the rails (5). One or more legs (50a), (50b), (50c) are then pushed downwards and inwards to disengage the locating pin (34) from the central hole (49) in the hub (48). The legs can then be folded back together so that the feet (52a), (52b), (52c) come together. The lower surfaces of the feet each have the shape of a 120° sector of a circle so that when they come together, they form a complete circle. The legs can then be pushed back into the housing against the force of the spring (44) until they are fully retracted whilst holding the spring loaded plunger (69) in the retracted position. Once the legs have been pushed fully into the housing, the spring loaded plunger (69) is released so that it springs back into engagement with the part annular groove in the feet of the tripod thereby to hold the tripod in the retracted state.

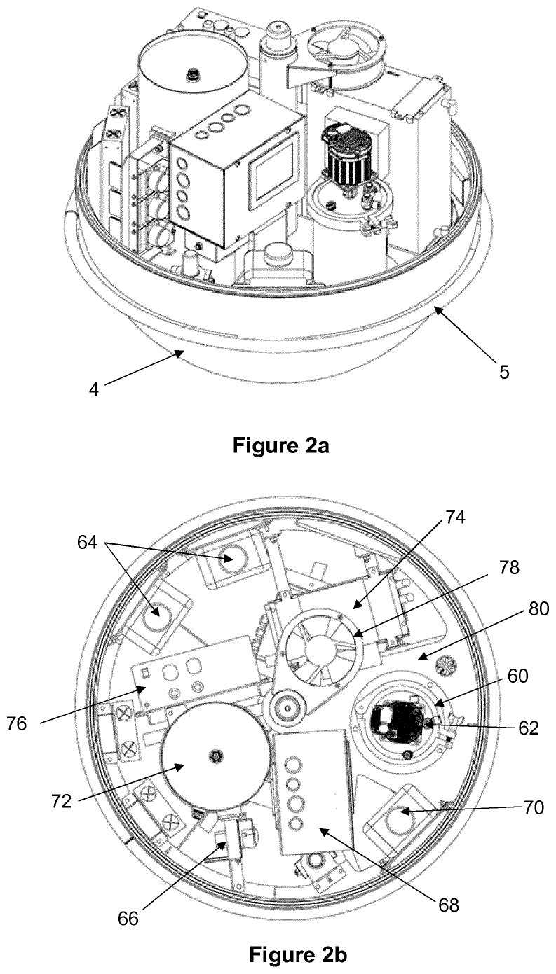

Inside the casing (2) are arranged various components of a reactor system for generating hydrogen and using the hydrogen thus generated to produce electricity. The components are shown in FIGS. 2a and 2b. Thus, the reactor system comprises a reactor vessel (60) equipped with a motorised mechanical stirrer (62), a pair of reactant containers (64) and peristaltic pumps (66) for pumping reactants from the reactant containers to the reactor vessel (60).

The reactant containers contain substances that can be reacted together to give hydrogen gas. By way of example, one reactant container can contain a solution of sodium hydroxide and the other reactant container can contain an aqueous suspension of aluminium particles and a suspending agent which can be, for example, a polysaccharide such as starch.

The pumping of reactants from the reactant containers (64) to the reactor vessel (60) is controlled by an electronic control system (68) which is linked to various sensors (not shown) that provide information on the pressure of hydrogen generated in the reactor vessel and other reaction parameters. The electronic control system is linked to a touch screen electronic interface unit (69) which is mounted in a window in the lower shell member (4)—see FIG. 4.

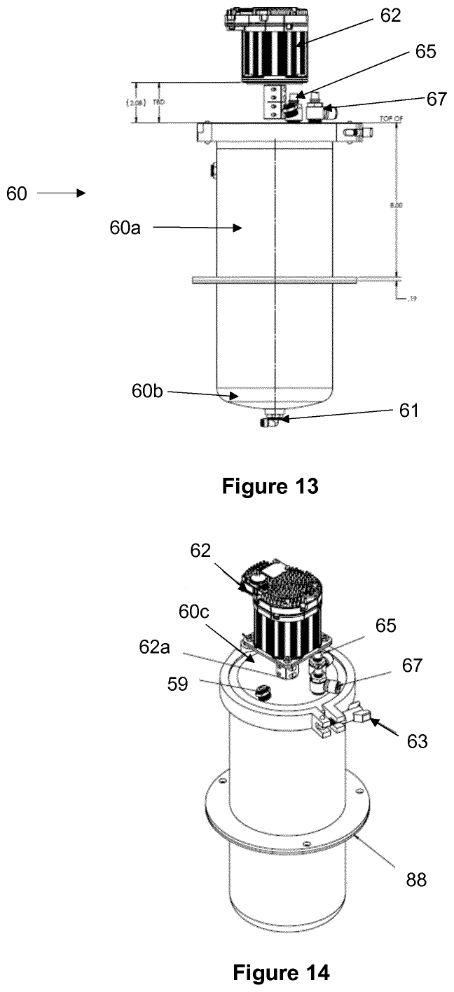

The reactor vessel (60) is shown in more detail in FIGS. 13 and 14. Thus, the reactor vessel (60) comprises a main body (60a) of generally cylindrical shape but with a flanged upper rim and a curved bottom or sump (60b) in which is located a waste outlet (61). A lid (60c) is secured to the flanged upper rim of the main body by means of a clamp (63), for example an ISO quick release flange clamp such as a Klein® flange clamp. A gasket (for example a copper gasket or gasket formed from an elastomeric material) is located between the lid and the flanged rim of the main body and provides a substantially gas-tight seal.

Set into the top of the reactor vessel is a gas-sealed stirrer gland (62a) in which is rotatably mounted a stirrer shaft. The stirrer shaft is provided at its lower end with a stirrer paddle. Attached to the top of the stirrer shaft is a removable motor (62) which is connected to an onboard power supply (not shown). The motor (62) can be removed and a hand crank attached to the shaft to enable manual operation of the stirrer when necessary.

Also set into the top of the reactor vessel are first and second reactant inlets (65) and (67) and hydrogen gas outlet (59). The first and second reactant inlets (65) and (67) are connected via gas-tight tubing (not shown) to peristaltic pumps (66) and from there by further lengths of gas-tight tubing (not shown) to first and second reactant containers (64).

The motorised mechanical stirrer (62) comprises a motor that drives a rotatable stirrer shaft which extends from the motor through a gas-sealed stirrer gland into the reactor vessel. A stirring paddle (not shown) is mounted on the lower end of the stirrer shaft inside the reactor vessel.

The waste outlet (61) at the lower end or sump of the reactor is connected by a length of tubing (not shown) to a waste container (70). An outlet of the waste container (70) is connected by tubing (not shown) to the reactor vessel (60) so that material from the waste container can be recycled back into the reactor vessel (60)

The reactor vessel (60) also has a gas outlet (59) through which hydrogen gas generated within the reactor can exit the reactor. The gas outlet (59) is connected via tubing (not shown) to a drying train comprising a water separator (not shown) and a desiccant dryer (not shown) containing a desiccant material. The outlet of the desiccant dryer is linked by tubing to a buffer tank (72) and the buffer tank (72) in turn is linked to a fuel cell (e.g. proton exchange membrane fuel cell) (74). Also located within the housing are an AC-DC power invertor (76) and a fan (78).

An on-board power supply (not shown) is also mounted within the casing. The power supply (which typically comprises one or more rechargeable batteries, provides the necessary electrical power for the peristaltic pumps, stirrer motor, electronic control system and any other power-consuming components when the generator is initially started up. Once the generator has started up, power can be taken from the PEM fuel cell. The batteries and other electrical control components are located in the base of the lower shell member (4).

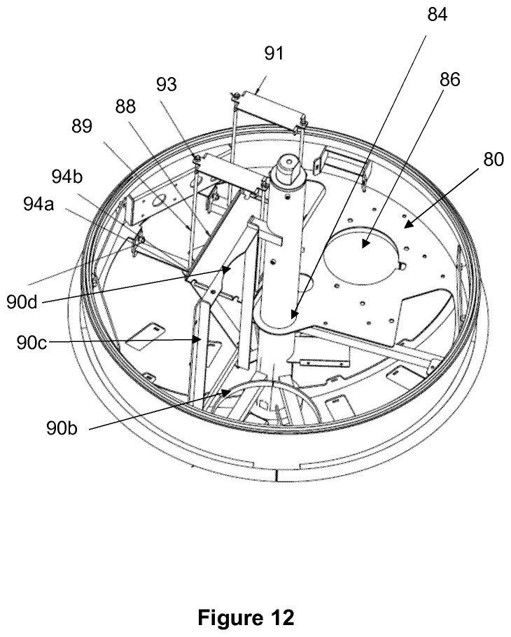

The internal components of the apparatus are arranged within the casing so that the weight is evenly distributed, thereby providing a smoother rolling action when the apparatus is being moved. In order to facilitate the placement and securing of the components, the interior of the casing contains various supporting structures that hold the components in place. As shown in FIGS. 3 and 12, a floor plate (80) is provided within the lower shell (4) to allow various components of the hydrogen generation apparatus to be secured in place. The floor plate is formed from a circular disc of aluminium in which holes have been cut to accommodate the various components of the hydrogen generation apparatus. The floor plate is welded to the side wall of the lower shell member (4) but is also partially supported by four arcuate strengthening ribs (82) (see FIG. 3) which extend from the base of the lower shell member (4) part way up the wall of the lower shell member and are welded in place. The ribs (82), along with the centre column (10) and the aluminium annular reinforcing member (8) provide extra rigidity to the casing.

The floor plate (80) has a hole (84) in its centre through which the centre column extends, and a larger diameter hole (86) within which the reactor vessel (60) is located. A support structure for the buffer tank (72) is provided (see FIG. 3) by base support strut (90a), a lower lateral support (90b), upright frame member (90c) and lateral frame member (90d). The lateral frame member (90d) has a chord-shaped cut-out corresponding to the curvature of the wall of the buffer tank (72).

A tray (88) provides a support for a PEM fuel cell. A retaining structure for the PEM fuel cell comprises threaded rods (89) which extend upwardly from the tray (88) and are secured to a retaining plate (91) by means of lock nuts (93). Each rod is secured at its lower end to the tray (88) by means of lock nut and washer combinations (94a, 94b)

The internal components of the apparatus are secured to the various supporting structures (not all of which are shown) by means of fastening devices such as bolts, brackets or clamps. The components are secured in such a way that allows the apparatus to be rolled without displacement of any of the components.

In use, the apparatus is switched on at the electronic interface unit (69) and reactants from the two reactant containers (64) are pumped into the reactor vessel (60). The two reactants (e.g. sodium hydroxide solution and a suspension of aluminium powder) are chosen such that when mixed they react to form hydrogen gas. The hydrogen gas generated in the reactor vessel exits the reactor vessel through the gas outlet and flows through the water separator and desiccant dryer to the buffer tank (72). Hydrogen from the buffer tank is then directed to the PEM fuel cell (74) where it is consumed to generate electricity. Where the output from the PEM fuel cell is DC current, the AC-DC power invertor (76) to convert the DC power generator by the fuel cell (74) to AC power which can then be used as the power source.

A proportion of the electricity produced by the PEM cell can be used to recharge the batteries, and a further proportion of the electricity can be used to power the electricity-consuming devices such as the motorised stirrer, peristaltic pumps and electronic controller. The remainder of the electricity generated can be carried by cable (not shown) to a connector (e.g. a plug socket) for connection to external electrical devices.

During operation of the apparatus, solid waste products typically accumulate in the sump section of the reactor vessel. The waste products can be removed through the waste outlet (61). However, because the waste products in the sump section may be mixed with partially reacted or unreacted reactants, it can be beneficial to recycle the mixture from the waste outlet (61) through a loop of tubing (not shown) and back into the reactor vessel (60) through a recycling inlet which is directed into the top of the reactor through its own inlet point, in order to maximise the amount of hydrogen obtained from the reactants. The recycling loop may optionally include one or more sensors that measure a reaction parameter indicative of the completeness of the chemical reaction within the reactor vessel. For example, the recycling loop may include a pH meter. The sensors (e.g. the pH meter) are linked to the electronic control electronic control system which can be programmed to vary the relative amounts of reactants pumped to the reactor vessel in response to signals received from the sensors so as to maintain the reaction parameter within a desired range. The recycling loop may include a further pump (e.g. a peristaltic pump (66)) which is linked electronically to the electronic control system (68). The electronic control system (68) may be programmed to permit no further new reactants (or only low levels of new reactants) to be introduced into the reactor vessel when the recycling loop is in operation.

At intervals, the flange clamp (63) can be disconnected and the lid (60c) of the reactor vessel can be removed so that the waste products can be mechanically removed from the reactor vessel and in particular the lower sump section. Alternatively or additionally, waste products can be sucked out of the sump section by the pump in the recycling loop and passed to waste through a waste outlet in the recycling loop instead of being recycled. In order to prevent the build-up of waste materials on the inner wall of the sump part of the reactor vessel, the paddle attached to the stirrer shaft may be shaped so that it conforms closely to the inner surface of the sump such that rotation of the paddle prevents accretion of waste material on the wall.

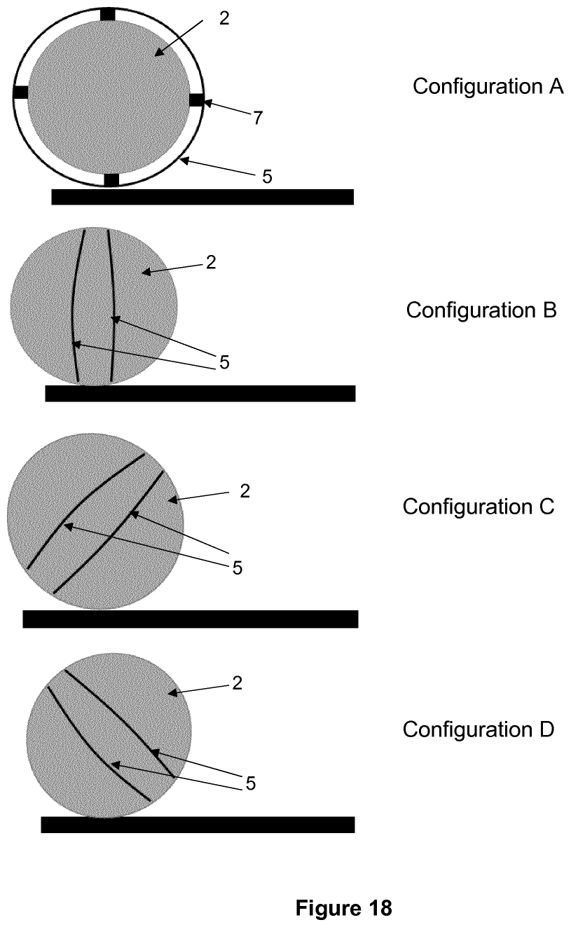

The apparatus of the invention is intended to be readily portable and should, ideally, be able to withstand rough treatment during transportation. Therefore, to test the durability of the apparatus, tests were conducted in which the apparatus was dropped from a height of 0.92 metres in various orientations (see FIG. 18) to ensure that it could withstand impact and still function properly. The apparatus was dropped in a number of different orientations from a raised platform located 0.92 m above the ground and any damage to the casing was observed and noted. The functioning of the apparatus was tested to determine whether this was affected by the drop impact. The results obtained are shown in the table below.

| | Orientation of | | Function of |
|---|---|---|---|
| Drop | Apparatus on | Observed Damage to | Apparatus |
| No. | raised platform | the Apparatus | Impaired? |
| 1 | A | Some flattening of the | Function of |
| | | upper circumferential | the apparatus |
| | | rail at impact point | not impaired |
| 2 | B | Some twisting of the | Function of |
| | | upper circumferential | the apparatus |
| | | rail at impact point. | not impaired |
| | | No damage to the welding | |
| | | of the rails to the body | |
| 3 | C | No visible damage | Function of |
| | | | the apparatus |
| | | | not impaired |
| 4 | D | Small dent at top of | Function of |
| | | upper shell near fitting | the apparatus |
| | | for the upper cap | not impaired. |

The results showed that, under the test conditions, the apparatus of FIGS. 1 to 14 suffered only relatively minor damage to the casing but the functioning of the apparatus was not impaired.

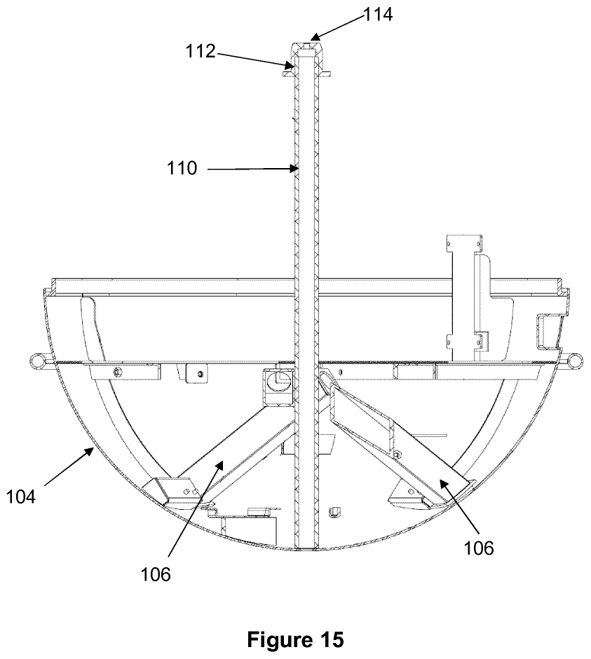

The apparatus shown in FIGS. 1 to 14 is provided with a centrally mounted tripod which supports the apparatus in an upright orientation during operation of the generator. As an alternative to a centrally mounted tripod, individual retractable legs may be provided instead and such an arrangement is shown in FIGS. 15, 16 and 17.

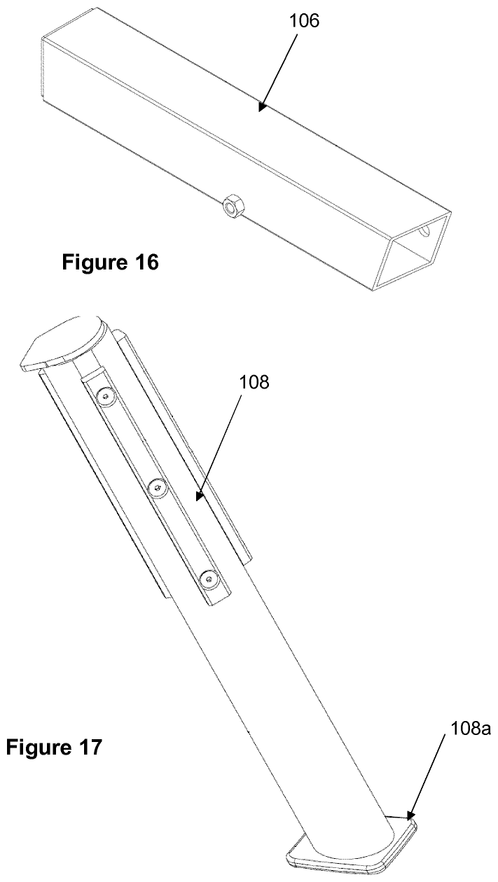

In this second embodiment, the lower shell member (104) has three rectangular openings equally spaced around the lower part of the lower shell member (104). Extending inwardly from the openings are three socket structures (106). Each socket structure (see FIG. 16) is formed from a length of rectangular cross-section tube, the lower ends of which are welded to the inner wall of the lower shell member (104). Within each socket structure is a leg (108) which is tubular in construction and has a circular cross-section. The outer end of each leg (108) terminates in a rectangular foot (108a) having a similar size to the rectangular holes in the holes in the lower shell member (104).

Because there is no centrally mounted tripod in the apparatus of FIGS. 15 to 17, the centre column (110) is slimmer than the centre column (10) in the embodiment of FIGS. 1 to 14 and there is no opening in the wall of the lower shell member (104) immediately below the lower end of the centre column (110). To the upper end of the centre column (110) is secured (by welding) a top piece (112) which has an external thread and a threaded central hole (114). An upper shell member (6) of the type illustrated in the apparatus of FIGS. 1 to 14 can be placed onto the lower shell member (104) so that the top piece (112) protrudes through the hole (18) in the recess (16) of the upper shell member (6). A nut or screw cap can then be screwed onto the external thread of the top piece (112) to hold the two shell members (104) and (6) together. An adjustable air vent cap (22) of the type shown in FIGS. 1, 6a and 6b can then be screwed into the threaded hole (114) in the top piece.

The internal component parts of the apparatus of FIGS. 15 to 17 are generally the same as the components in the apparatus shown in FIGS. 1 to 14, except that the arrangement of some of the components differs because of the reduced space inside the casing resulting from the presence of the three socket structures. Thus, for example, whereas the buffer tank (72) in the embodiment of FIGS. 1 to 14 is in an upright orientation, the buffer tank (not shown) in the apparatus of FIGS. 15 to 17 lies horizontally.

The embodiments described above and illustrated in the accompanying figures and tables are merely illustrative of the invention and are not intended to have any limiting effect. It will readily be apparent that numerous modifications and alterations may be made to the specific embodiments shown without departing from the principles underlying the invention. All such modifications and alterations are intended to be embraced by this application.

1. An apparatus comprising a generator enclosed within a casing shaped to allow it to be rolled about one or more axes, the apparatus being provided with stabilising means that can be arranged to hold the apparatus in a desired orientation on an underlying surface and prevent the apparatus from rolling on the underlying surface when it is desired to use the generator.

2. An apparatus according to claim 1 wherein the stabilising means comprise one or more movable elements that can be moved or removed to prevent the apparatus from rolling when in use.

3. An apparatus according to claim 2 wherein the movable elements are arranged to move between a stowed configuration, in which rolling of the apparatus is not impeded, and an extended configuration in which the movable elements prevent rolling of the apparatus from taking place.

4. An apparatus according to claim 1 wherein the generator comprises a chemical reactor for generating hydrogen.

5. An apparatus according to claim 4 which comprises a hydrogen-consuming electricity-generating device.

6. An apparatus according to claim 5 wherein the hydrogen-consuming device is contained within the casing.

7. An apparatus according to claim 5 wherein the hydrogen-consuming device is a fuel cell.

8. An apparatus according to claim 1 which has a single axis of rotation.

9. An apparatus according to claim 1 wherein the casing comprises a substantially spherical casing body.

10. An apparatus according to claim 1 wherein the casing comprises a main body and one or more ground engaging elements which are configured to allow the casing to be rolled.

11. An apparatus according to claim 10 wherein the ground engaging elements comprise a plurality (e.g. two) of rails which are circular or substantially circular in shape and encircle the casing.

12. An apparatus according to claim 1 wherein the casing comprises a substantially spherical casing body, and the casing body is provided with one or more bracing struts which each extend from one location on an inner wall of the casing body across the interior of the casing body to another location on an inner wall of the casing body.

13. An apparatus according to claim 12 wherein a bracing strut extends across the interior of the casing body and takes the form of a centrally located column, connecting two opposite locations on an inner surface of the body.

14. An apparatus according to claim 9 wherein the casing body comprises a pair of substantially hemispherical shell members that are removably or hingedly connected together.

15. An apparatus according to claim 1 wherein the stabilising means comprises a plurality of retractable legs.

16. An apparatus according to claim 15 wherein the retractable legs are present in the form of a single retractable tripod which is typically arranged to fold or collapse to enable it to be retracted into the casing body.

17. An apparatus according to claim 1, wherein the apparatus comprises a plurality of components that together constitute a reaction system for generating hydrogen, and the components are selected from:
a reactor (in which two or more substances can be reacted to form gaseous hydrogen);
electronic monitoring and control means for monitoring and controlling the reaction between the reactants;
and optionally one or more further components selected from:
one or more pumps (e.g. peristaltic pumps) for pumping the reactants into the reactor;
a waste container for collecting spent reactants;
a buffer tank for temporary storage of hydrogen;
one or more sensors (e.g. selected from a temperature sensor, pressure sensor and optionally a pH sensor) for monitoring a physical or chemical parameter of the reaction system, the one or more sensors being operatively linked to the electronic monitoring and control means;
one or more filters or driers (e.g., desiccant air driers) for removing water from the hydrogen;
one or more electrical components selected from electrical converters (e.g. voltage converters or frequency converters), voltage regulators, power inverters, batteries and capacitors.

18. An apparatus substantially as described herein with reference to the accompanying drawings.
